(19) United States
(12) Patent Application Publication
(10) Pub. No.: US 2025/0149754 A1
(43) Pub. Date: May 8, 2025

(54) SOLID-STATE BATTERY AND ELECTRONIC DEVICE

(71) Applicant: Murata Manufacturing Co., Ltd., Nagaokakyo-shi (JP)

(72) Inventor: Takashi KASASHIMA, Nagaokakyo-shi (JP)

(21) Appl. No.: 19/015,860

(22) Filed: Jan. 10, 2025

Related U.S. Application Data
(63) Continuation of application No. PCT/JP2023/023289, filed on Jun. 23, 2023.

(30) Foreign Application Priority Data
Jul. 13, 2022 (JP) 2022-112552

(51) Int. Cl. H01M 50/533; H01M 10/058; H01M 50/46

(52) U.S. Cl. CPC H01M 50/533; H01M 10/058; H01M 50/46

(57) ABSTRACT

A solid-state battery that includes: a plurality of solid-state battery elements in which a positive electrode layer, a negative electrode layer, and a solid-state electrolyte layer interposed therebetween are stacked; and an interlayer conductive layer sandwiched between the positive or the negative electrode layer of a first solid-state battery element and the positive or the negative electrode layer of a second solid-state battery element of the plurality of solid-state battery elements, wherein the positive or the negative electrode layer sandwiching the interlayer conductive layer contains a solid-state electrolyte, a solid-state electrolyte ratio of the positive or the negative electrode layer sandwiching the interlayer conductive layer is 40 wt % to 60 wt % based on an entirety of the positive or the negative electrode layer, and a solid-state electrolyte ratio of the interlayer conductive layer is 10 wt % to 35 wt % based on an entirety of the interlayer conductive layer.

### CROSS REFERENCE TO RELATED APPLICATIONS

The present application is a continuation of International application No. PCT/JP2023/023289, filed Jun. 23, 2023, which claims priority to Japanese Patent Application No. 2022-112552, filed Jul. 13, 2022, the entire contents of each of which are incorporated herein by reference.

### TECHNICAL FIELD

The present disclosure relates to a solid-state battery and an electronic device.

### BACKGROUND ART

Conventionally, secondary batteries that can be repeatedly charged and discharged have been used for various purposes. For example, secondary batteries are used as power sources of electronic devices such as smart phones and notebook computers.

In a secondary battery, a liquid electrolyte is generally used as a medium for ion transfer that contributes to charge and discharge. That is, a so-called electrolytic solution is used for the secondary battery. However, in such a secondary battery, safety is generally required in terms of preventing leakage of the electrolytic solution. Since an organic solvent or the like used for the electrolytic solution is a flammable substance, safety is required also in that respect.

Therefore, a solid-state battery using a solid-state electrolyte instead of the electrolytic solution has been studied.
Patent Document 1: Japanese Patent Application Laid-Open No. 2018-166020

### SUMMARY OF THE DISCLOSURE

It is generally known that a volume change occurs in the positive electrode or the negative electrode during charging and discharging of the battery, and there is a possibility that breakage of the battery occurs due to a stress based on the volume change. Various countermeasures against breakage of the battery have been studied.

For example, Patent Document 1 discloses a configuration in which an interface between a positive electrode layer and a solid-state electrolyte layer and an interface between a negative electrode layer and a solid-state electrolyte are intertwined with each other as an all-solid-state battery having no cracking, warpage, or cracking or peeling between layers. According to Patent Document 1, by increasing the adhesive strength between the respective layers, cracking and warpage, and cracking and peeling between the respective layers are less likely to occur (refer to paragraph of Patent Document 1).

However, the all-solid-state battery described in Patent Document 1 is not configured to release (alleviate) a stress based on the volume change, and there is a possibility that the stress is accumulated, leading to breakage of the battery.

The present disclosure has been devised in view of such problems. That is, a main object of the present disclosure is to provide a solid-state battery and an electronic device capable of alleviating a stress based on a volume change.

The inventor of the present application has tried to solve the above problem by addressing the problem in a new direction instead of addressing the same in an extension of a conventional technique. As a result, the present inventors have reached a solid-state battery in which the main object is achieved.

A solid-state battery according to the present disclosure includes: a plurality of solid-state battery elements in which a positive electrode layer, a negative electrode layer, and a solid-state electrolyte layer interposed between the positive electrode layer and the negative electrode layer are stacked; and an interlayer conductive layer sandwiched between the positive electrode layer or the negative electrode layer of a first solid-state battery element and the positive electrode layer or the negative electrode layer of a second solid-state battery element of the plurality of solid-state battery elements, wherein the positive electrode layer or the negative electrode layer sandwiching the interlayer conductive layer contains a solid-state electrolyte, a solid-state electrolyte ratio of the positive electrode layer or the negative electrode layer sandwiching the interlayer conductive layer is 40 wt % to 60 wt % based on an entirety of the positive electrode layer or the negative electrode layer, and a solid-state electrolyte ratio of the interlayer conductive layer is 10 wt % to 35 wt % based on an entirety of the interlayer conductive layer.

Further, on an electronic device according to the present disclosure, the solid-state battery described above is surface-mounted.

According to the present disclosure, it is possible to provide a solid-state battery and an electronic device capable of alleviating a stress based on a volume change.

### BRIEF EXPLANATION OF THE DRAWINGS

FIG. 1 is a sectional view of a main portion of a solid-state battery of the present disclosure.

FIG. 2 is a sectional view of a main portion of a modification of the solid-state battery of the present disclosure.

FIG. 3 is a sectional view of a main portion of a modification of the solid-state battery of the present disclosure.

FIG. 4 is a sectional view of the solid-state battery of the present disclosure.

FIGS. 5(a) and 5(b) are process sectional views illustrating a process for manufacturing a solid-state battery of the present disclosure.

### DESCRIPTION OF THE PREFERRED EMBODIMENTS

Hereinafter, the “solid-state battery” of the present disclosure and the “electronic device” on which the solid-state battery is surface-mounted will be described in detail. Although the description will be made with reference to the drawings as necessary, the illustrated contents are only schematically and exemplarily illustrated for the understanding of the present disclosure, and the appearance, the dimensional ratio, or the like may be different from the actual ones.

First, the “solid-state battery” according to one embodiment of the present disclosure will be described. The “solid-state battery” referred to in the present disclosure refers to a battery whose constituent elements are composed of a solid in a broad sense, and refers to an all-solid-state battery whose battery constituent elements (particularly preferably all battery constituent elements) are composed of a solid in a narrow sense. In a preferred aspect, the solid-state battery in the present disclosure is a stacked solid-state battery configured such that layers constituting a battery constituent unit are stacked with each other, and preferably such layers may be made of a fired body. Note that the “solid-state battery” includes not only a so-called “secondary battery” capable of repeating charging and discharging but also a “primary battery” capable of only discharging. According to a preferred embodiment of the present disclosure, the “solid-state battery” is a secondary battery. The “secondary battery” is not excessively limited by its name, and may include, for example, a power storage device and the like.

The “plan view” as used herein is based on a form in which an object is captured from above or below along the thickness direction based on the stacking direction of each layer constituting the solid-state battery. The term “sectional view” used in the present specification is on the basis of a form in the case of viewing an object from a direction substantially perpendicular to the thickness direction based on the stacking direction in which each layer constituting the solid-state battery is stacked (to put it briefly, a form in the case of cutting an object along a plane parallel to the thickness direction). The terms “vertical direction” and “horizontal direction” used directly or indirectly in the present specification correspond to a vertical direction and a horizontal direction in the drawings, respectively. Unless otherwise specified, the same reference signs or symbols shall denote the same members or sites or the same meanings. According to a preferred aspect, it can be understood that the downward direction in the vertical direction (i.e., the direction in which gravity acts) corresponds to a “downward direction”, whereas the opposite direction corresponds to an “upward direction”. Further, in the description in the present specification, reference to a direction, an orientation, or the like is merely for convenience of description, and is not intended to limit the scope of the present disclosure unless otherwise explicitly described. For example, relative terms such as “outside (or outer side)”, “inside (or inner side)” and their derivatives should be understood to refer to directions as described or illustrated. That is, unless otherwise explicitly described, the disclosure is not limited only to a specific direction, orientation, form, or the like. In addition, terms such as “provided” and “disposed”, and derivative terms thereof are also similar, and are not limited to a direct mode, and may be a mode in which another element such as an inclusion is interposed unless otherwise explicitly described.

### [Configuration of Solid-State Battery]

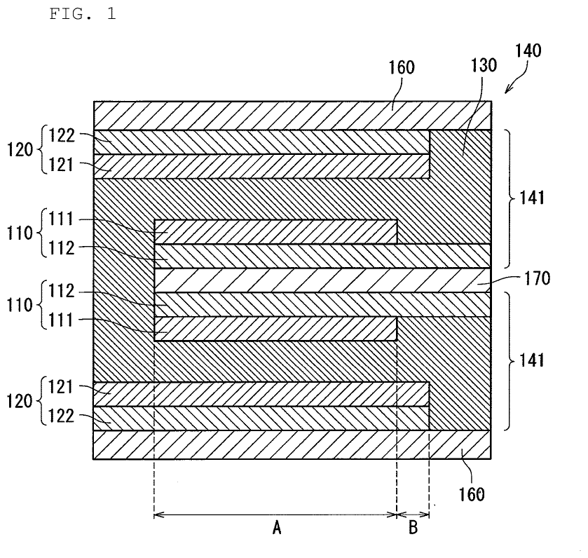

A solid-state battery 100 (refer to FIGS. 1 to 4) includes a laminate 140 which includes: solid-state battery elements 141 each including a battery constituent unit including a positive electrode layer 110, a negative electrode layer 120, and a solid-state electrolyte layer 130 at least interposed therebetween; and an interlayer conductive layer 170 located between the respective solid-state battery elements 141. The interlayer conductive layer 170 is sandwiched between the positive electrode layer 110 or the negative electrode layer 120 of one solid-state battery element 141 and the positive electrode layer 110 or the negative electrode layer 120 of another solid-state battery element 141. The positive electrode layer 110 or the negative electrode layer 120 sandwiching the interlayer conductive layer 170 contains a solid-state electrolyte, a solid-state electrolyte ratio of the positive electrode layer 110 or the negative electrode layer 120 sandwiching the interlayer conductive layer 170 is 40 wt % to 60 wt % based on the layer containing a solid-state electrolyte, and a solid-state electrolyte ratio of the interlayer conductive layer 170 is 10 wt % to 35 wt % based on the layer containing a solid-state electrolyte.

According to the solid-state battery 100 of the present disclosure, the solid-state electrolyte ratio of the interlayer conductive layer 170 is smaller than the solid-state electrolyte ratio of the positive electrode layer 110 or the negative electrode layer 120 sandwiching the interlayer conductive layer 170. Here, when the solid-state electrolyte ratio is small, the strength of the layer structure is lowered. Therefore, the strength of the interlayer conductive layer 170 is relatively lower than the strength of the positive electrode layer 110 or the negative electrode layer 120 sandwiching the interlayer conductive layer 170. Thus, when a stress is accumulated inside the solid-state battery, the stress can be concentrated on the interlayer conductive layer 170 having a low strength. As an example, a stress can be alleviated by causing cracks in the interlayer conductive layer 170.

Further, the interlayer conductive layer 170 contributes less to the solid-state battery characteristics than the solid-state battery element 141. Therefore, if a stress concentrates on the interlayer conductive layer 170 and a load is applied, and cracks occur, the influence on the solid-state battery characteristics is small. In other words, by applying a load to the interlayer conductive layer 170 side, it is possible to reduce application of a load to the solid-state battery element 141 side, so that deterioration of solid-state battery characteristics can be prevented.

Further, by setting the solid-state electrolyte ratio of the positive electrode layer 110 or the negative electrode layer 120 sandwiching the interlayer conductive layer 170 and the solid-state electrolyte ratio of the interlayer conductive layer 170 within the above numerical ranges, the production aptitude of the solid-state battery can be maintained. Hereinafter, the solid-state battery of the present disclosure will be described in detail.

### 1. Solid-State Battery Element

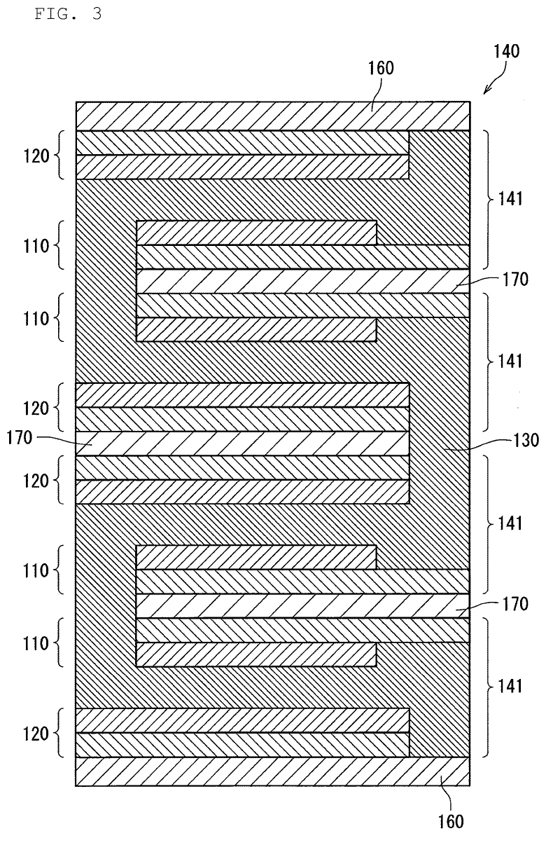

The solid-state battery element 141 is a battery constituent unit including the positive electrode layer 110, the negative electrode layer 120, and the solid-state electrolyte layer 130 at least interposed therebetween. A plurality of the solid-state battery elements 141 may be stacked with the interlayer conductive layer 170 interposed therebetween. As an example, in FIG. 1, two solid-state battery elements 141 may be stacked with the interlayer conductive layer 170 interposed therebetween. As another example, in FIG. 3, four solid-state battery elements 141 may be stacked with the interlayer conductive layer 170 interposed therebetween. More specifically, the plurality of solid-state battery elements 141 may be electrically connected in parallel to each other. Desired battery characteristics can be obtained by electrically connecting a plurality of solid-state battery elements in parallel.

The solid-state battery element 141 may be formed by firing each layer. That is, the positive electrode layer 110, the negative electrode layer 120, the solid-state electrolyte layer 130, and the like may form a sintered layer. Preferably, the positive electrode layer 110, the negative electrode layer 120, and the solid-state electrolyte layer 130 are integrally fired with each other, and may be formed of a sintered body. More preferably, the laminate 140 in which the interlayer conductive layer 170 is interposed between the plurality of solid-state battery elements 141 may be integrally fired with each other to form an integrally sintered body. In the present specification, a direction (vertical direction) in which the positive electrode layer and the negative electrode layer are stacked is referred to as a “stacking direction”, and a direction intersecting the stacking direction is a horizontal direction in which the positive electrode layer and the negative electrode layer extend.

### 1-1. Positive Electrode Layer and Negative Electrode Layer

The positive electrode layer 110 may be an electrode layer including at least a positive electrode active material layer 111 and a positive electrode current collector layer 112. In a preferred aspect, the positive electrode active material layer 111 may include a sintered body including at least positive electrode active material particles and solid electrolyte particles. Further, the positive electrode current collector layer 112 may further contain a solid-state electrolyte. On the other hand, the negative electrode layer 120 may be an electrode layer including at least a negative electrode active material layer 121 and a negative electrode current collector layer 122. In a preferred aspect, the negative electrode active material layer 121 may include a sintered body including at least negative electrode active material particles and solid electrolyte particles. Further, the negative electrode current collector layer 122 may further contain a solid-state electrolyte.

Here, the positive electrode active material and the negative electrode active material are substances involved in accepting and donating of electrons in the solid-state battery. Ion movement (or conduction) between the positive electrode layer and the negative electrode layer with the solid-state electrolyte interposed therebetween and accepting and donating of electrons between the positive electrode layer and the negative electrode layer with an external terminal interposed therebetween are performed, so that charge and discharge are performed.

The illustrated examples (FIGS. 1 to 3) illustrate a configuration of the positive electrode layer 110 in which one layer of the positive electrode active material layer 111 and one layer of the positive electrode current collector layer 112 are stacked, and the negative electrode layer 120 in which one layer of the negative electrode active material layer 121 and one layer of the negative electrode current collector layer 122 are stacked, per one solid-state battery element 141. However, the number of stacked layers is not limited to this example, and the active material layer and the current collector layer may be two or more layers. The film thickness of the positive electrode layer 110 or the negative electrode layer 120 may be 5 μm to 60 μm, and preferably 8 μm to 50 μm. The film thickness may be 5 μm to 30 μm.

### (Positive Electrode Active Material Layer)

The positive electrode active material contained in the positive electrode active material layer 111 may be, for example, a lithium-containing compound or a sodium-containing compound. That is, it may be a layer capable of occluding and releasing lithium ions or sodium ions. The type of the lithium-containing compound is not particularly limited, and examples of the lithium-containing compound include a lithium transition metal composite oxide and/or a lithium transition metal phosphate compound. The lithium transition metal composite oxide is a generic term for oxides containing lithium and one or two or more types of transition metal elements as constituent elements. The lithium transition metal phosphate compound is a generic term for phosphate compounds containing lithium and one or two or more types of transition metal elements as constituent elements. The type of transition metal element is not particularly limited, and examples of the transition metal element include cobalt (Co), nickel (Ni), manganese (Mn), and/or iron (Fe).

The lithium transition metal composite oxide is, for example, a compound represented by LiₓM1O₂ and Li_{y}M2O₄. The lithium transition metal phosphate compound is, for example, a compound represented by Li_{z}M3PO₄. Note that, each of M1, M2, and M3 is one or two or more types of transition metal elements. The respective values of x, y, and z are optional.

Specifically, examples of the lithium transition metal composite oxide include LiCoO₂, LiNiO₂, LiVO₂, LiCrO₂, LiMn₂O₄, LiCO_{1/3}Ni_{1/3}Mn_{1/3}O₂, and LiNi_{0.5}Mn_{1.5}O₄. Examples of the lithium transition metal phosphate compound include LiFePO₄, LiCoPO₄, and LiMnPO₄. The lithium transition metal composite oxide (particularly LiCoO₂) may contain a trace amount (about several %) of an additive element. Examples of the additive element include one or more types of elements selected from the group consisting of aluminum (Al), magnesium (Mg), nickel (Ni), manganese (Mn), titanium (Ti), boron (B), vanadium (V), chromium (Cr), iron (Fe), copper (Cu), zinc (Zn), molybdenum (Mo), tin (Sn), tungsten (W), zirconium (Zr), yttrium (Y), niobium (Nb), calcium (Ca), strontium (Sr), bismuth (Bi), sodium (Na), potassium (K), and silicon (Si).

In addition, examples of the positive electrode active material capable of occluding and releasing sodium ions include at least one selected from the group consisting of sodium-containing phosphate compounds having a NASICON-type structure, sodium-containing phosphate compounds having an olivine-type structure, sodium-containing layered oxides, sodium-containing oxides having a spinel-type structure, and the like. For example, in the case of the sodium-containing phosphate compounds, examples thereof include at least one type selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, Na₄Fe₃(PO₄)₂(P₂O₇), and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

The content of the positive electrode active material in the positive electrode active material layer 111 is usually 50 wt % or more, for example, 60 wt % or more with respect to the total amount of the positive electrode active material layer 111. The positive electrode active material layer 111 may contain two or more types of the positive electrode active materials, and in that case, the total content thereof may be within the above range. When the content of the active material is 50 mass % or more, the energy density of the battery can be particularly increased.

### (Negative Electrode Active Material Layer)

Examples of the negative electrode active material contained in the negative electrode active material layer 121 include a carbon material, a metal-based material, a lithium alloy and/or a lithium-containing compound.

Specifically, examples of the carbon material include graphite, graphitizable carbon, non-graphitizable carbon, mesocarbon microbeads (MCMB), and/or highly oriented graphite (HOPG).

The metal-based material is a generic term for a material containing any one or two or more types of metal elements and metalloid elements capable of forming alloy with lithium as constituent elements. The metal-based material may be a simple substance, an alloy, or a compound. Since the purity of the simple substance described here is not necessarily limited to 100%, the simple substance may contain a trace amount of impurities.

Examples of the metal element and the metalloid element include silicon (Si), tin (Sn), aluminum (Al), indium (In), magnesium (Mg), boron (B), gallium (Ga), germanium (Ge), lead (Pb), bismuth (Bi), cadmium (Cd), titanium (Ti), chromium (Cr), iron (Fe), niobium (Nb), molybdenum (Mo), silver (Ag), zinc (Zn), hafnium (Hf), zirconium (Zr), yttrium (Y), palladium (Pd), and/or platinum (Pt).

Specifically, examples of the metal-based material include Si, Sn, SiB₄, TiSi₂, SiC, Si₃N₄, SiOᵥ (0<v≤2), LiSiO, SnO_{w} (0<w≤2), SnSiO₃, LiSnO, and/or Mg₂Sn.

The lithium-containing compound is, for example, a lithium transition metal composite oxide. The definition regarding the lithium transition metal composite oxide is as described above. Specifically, the lithium transition metal composite oxide is, for example, Li₃V₂(PO₄)₃, Li₃Fe₂(PO₄)₃, Li₄Ti₅O₁₂, LiTi₂(PO₄)₃, and/or LiCuPO₄.

Examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The content of the negative electrode active material in the negative electrode active material layer 121 is usually 50 wt % or more, for example, 60 wt % or more with respect to the total amount of the negative electrode active material portion. The negative electrode active material portion may contain two or more types of negative electrode active materials, and in that case, the total content thereof may be within the above range. When the content of the active material is 50 mass % or more, the energy density of the battery can be particularly increased.

As a preferred aspect of the active material layer, the positive electrode active material layer 111 and/or the negative electrode active material layer 121 may contain a conductive material. Examples of the conductive material contained in the positive electrode active material layer 111 and/or the negative electrode active material layer 121 include a carbon material and a metal material. Specific examples of the carbon material include graphite and carbon nanotubes. Examples of the metal material include copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and/or palladium (Pd), and the metal material may also be an alloy of two or more thereof.

Further, the positive electrode active material layer 111 and/or the negative electrode active material layer 121 may contain a binder. The binder is, for example, any one or two or more types of synthetic rubbers and polymer materials. Specifically, examples of the synthetic rubber include styrene-butadiene-based rubber, fluorine-based rubber, and/or ethylene propylene diene. Examples of the polymer material include at least one selected from the group consisting of polyvinylidene fluoride, polyimide, and an acrylic resin.

Further, the positive electrode active material layer 111 and/or the negative electrode active material layer 121 may contain a sintering aid. Examples of the sintering aid include at least one type selected from the group consisting of a lithium oxide, a sodium oxide, a potassium oxide, a boron oxide, a silicon oxide, a bismuth oxide, and a phosphorus oxide.

Further, the thickness of each of the positive electrode active material layer 111 and the negative electrode active material layer 121 is not particularly limited, and may be, for example, 2 μm to 100 μm, and particularly 5 μm to 50 μm, independently of each other.

Further, the positive electrode active material layer 111 or the negative electrode active material layer 121 located on both sides of the interlayer conductive layer 170 described later may be disposed inside the active material layer of a facing counter electrode. Specifically, in the illustrated example (FIG. 1), the positive electrode active material layer 111 may be disposed inside the facing negative electrode active material layer 121. The above arrangement results from the fact that when there is a positive electrode portion not facing the negative electrode, dendrite is generated on the negative electrode side, and a short circuit may occur. In addition, in the solid-state battery of the present disclosure, a compressive stress is applied by charging and discharging in a region A where the active material layers facing each other are opposed to each other, and a tensile stress is applied by charging and discharging in a region B where the active material layers facing each other are not opposed to each other, but the stress can be appropriately alleviated by the interlayer conductive layer 170 described later.

### (Positive Electrode Current Collector Layer and Negative Electrode Current Collector Layer)

The positive electrode current collector layer 112 and the negative electrode current collector layer 122 preferably have higher electron conductivity than those of the positive electrode active material layer 111 and the negative electrode active material layer 121. In other words, the positive electrode current collector layer 112 and the negative electrode current collector layer 122 are used for collecting current between the positive electrode layers 110 or between the negative electrode layers 120. As a specific constituent material, the positive electrode current collector layer 112 and the negative electrode current collector layer 122 may contain a conductive material and a solid-state electrolyte.

As the conductive material used for the positive electrode current collector layer 112, for example, at least one selected from the group consisting of a carbon material, silver, palladium, gold, platinum, aluminum, copper, a nickel lithium transition metal composite oxide, and a lithium transition metal phosphate compound may be used.

As the conductive material used for the negative electrode current collector layer 122, at least one selected from the group consisting of a carbon material, silver, palladium, gold, platinum, aluminum, copper, and nickel may be used.

A specific material of the solid-state electrolyte will be described later in detail in “1-2. Solid-state electrolyte layer”.

The solid-state electrolyte ratio is 40 wt % to 60 wt % based on the entire positive electrode current collector layer 112 or negative electrode current collector layer 122. Note that, in the present disclosure, since the positive electrode current collector layer 112 and the negative electrode current collector layer 122 are composed of a conductive material and a solid-state electrolyte, when the solid-state electrolyte ratio in the current collector layer is 40 wt % on the whole basis, the conductive material is 60 wt %. Further, when the solid-state electrolyte ratio in the current collector layer is 60 wt % on the whole basis, the conductive material is 40 wt %. When the numerical range is satisfied, the strength of the positive electrode current collector layer 112 and the negative electrode current collector layer 122 can be increased. Therefore, when the stress is accumulated inside the solid-state battery, breakage of the positive electrode current collector layer 112 and the negative electrode current collector layer 122 can be reduced. Note that details of the numerical range of the solid-state electrolyte ratio will be described later in “Examples”.

The positive electrode current collector layer 112 and/or the negative electrode current collector layer 122 may have a form of a fired body. That is, it may be composed of a fired body containing an active material, a binder, and/or a sintering aid in addition to the conductive material and the solid-state electrolyte described above. Further, the positive electrode current collector layer 112 and/or the negative electrode current collector layer 122 may also contain a heat-resistant resin. When the current collector layer contains a heat-resistant resin, cracks generated by expansion of the current collector layer can be suppressed.

The thickness of each of the positive electrode current collector layer 112 and the negative electrode current collector layer 122 is not particularly limited, and may be, for example, 1 μm to 100 μm, and particularly 1 μm to 50 μm, independently of each other.

As a preferred aspect of the positive electrode current collector layer 112 and the negative electrode current collector layer 122, the positive electrode current collector layer 112 or the negative electrode current collector layer 122 sandwiching the interlayer conductive layer 170 may be exposed from the positive electrode active material layer 111 or the negative electrode active material layer 121 located on both sides of the interlayer conductive layer 170. The “aspect in which the current collector layer sandwiching the interlayer conductive layer is exposed from the active material layers located on both sides of the interlayer conductive layer” as used herein intends an aspect in which the current collector layer sandwiching the interlayer conductive layer is exposed to the active material layers located on both sides of the interlayer conductive layer. In other words, the aspect intends an aspect in which the current collector layer sandwiching the interlayer conductive layer is exposed because the length of the current collector layer is longer than the active material layers located on both sides of the interlayer conductive layer. In the illustrated example (FIG. 1), the positive electrode current collector layer 112 extends so as to be exposed from the solid-state battery element 141, but the positive electrode active material layer 111 may not extend so as to be exposed from the solid-state battery element 141. With such a configuration, the positive electrode current collector layer 112 and the negative electrode current collector layer 122 exposed from the solid-state battery element 141 can be appropriately wired to terminal electrodes 151, 152. In addition, the positive electrode active material layer 111 or the negative electrode active material layer 121 involved in accepting and donating of electrons can be appropriately protected without being exposed.

### 1-2. Solid-State Electrolyte Layer

The solid-state electrolyte constituting the solid-state electrolyte layer 130 is a material capable of conducting lithium ions or sodium ions. In particular, the solid-state electrolyte constituting a battery constituent unit in the solid-state battery forms a layer capable of conducting lithium ions or sodium ions between the positive electrode layer 110 and the negative electrode layer 120. The solid-state electrolyte layer has only to be provided at least between the positive electrode layer 110 and the negative electrode layer 120. Specific examples of the solid-state electrolyte contained in the solid-state electrolyte layer include any one or two or more types of a crystalline solid-state electrolyte, a glass-based solid-state electrolyte, and a glass ceramic-based solid-state electrolyte.

Examples of the crystalline solid-state electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compound that has a NASICON structure include LiₓM_{y}(PO₄)₃ (1≤x≤2, 1≤y≤2, M is at least one type selected from the group consisting of titanium (Ti), germanium (Ge), aluminum (Al), gallium (Ga), and zirconium (Zr)). An example of the lithium-containing phosphate compound having a NASICON structure includes Li_{1.2}Al_{0.2}Ti_{1.8}(PO₄)₃. An example of the oxides that have a perovskite structure includes La_{0.55}Li_{0.35}TiO₃. An example of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and Li₁₀GeP₂S₁₂. The crystalline solid-state electrolyte may contain a polymer material (for example, a polyethylene oxide (PEO)).

Examples of the glass-based solid-state electrolyte include oxide-based glass materials and sulfide-based glass materials. In addition, examples of the oxide-based glass material include Li₂O—SiO₂, Li₂O—Al₂O₃—TiO₂—P₂O₅, 54Li₂O-11SiO₂-35B₂O₃, 50Li₄SiO₄-50Li₃BO₃, 23.3Li₂O-76.7GeO₂, and/or 60Li₂O-40P₂O₅. In other words, the oxide-based glass material may contain at least one selected from the group consisting of lithium, silicon, and boron. The oxide-based glass material essentially contains lithium oxide, and may contain at least one selected from the group consisting of germanium oxide, silicon oxide, boron oxide, and phosphorus oxide. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and/or 50Li₂S-50GeS₂.

Examples of the glass ceramic-based solid-state electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In other words, the oxide-based glass ceramic material may contain at least one selected from the group consisting of lithium, silicon, and boron. Examples thereof include 90Li₃BO₃-10Li₂SO₄. The oxide-based glass ceramic material essentially contains lithium oxide, and may contain at least one selected from the group consisting of germanium oxide, silicon oxide, boron oxide, and phosphorus oxide. In addition, examples of the sulfide-based glass ceramic materials include Li₇P₃S₁₁ and Li_{3.25}P_{0.95}S₄.

When more emphasis is placed on the viewpoint of achieving excellent atmospheric stability and easy integral sintering, the solid-state electrolyte may contain at least one selected from the group consisting of an oxide-based crystal material, an oxide-based glass material, and an oxide-based glass ceramic material.

Examples of the solid-state electrolyte capable of conducting sodium ions include a sodium-containing phosphate compound having a NASICON structure, an oxide having a perovskite structure, and an oxide having a garnet-type structure or a garnet-type similar structure. Examples of the sodium-containing phosphate compounds that have a NASICON structure include NaₓM_{y}(PO₄)₃ (1≤x≤2, 1≤y≤2, and M is at least one type selected from the group consisting of Ti, Ge, Al, Ga, and Zr).

The solid-state electrolyte layer may contain a binder and/or a sintering aid. The binder and/or the sintering aid contained in the solid-state electrolyte layer may be selected from, for example, materials similar to the binder and/or the sintering aid that can be contained in the positive electrode active material portion and/or the negative electrode active material portion.

The thickness of the solid-state electrolyte layer is not particularly limited, and may be, for example, 1 μm to 15 μm, particularly 1 μm to 5 μm.

As a preferred aspect of the solid-state electrolyte layer 130, the solid-state electrolyte layer 130 may cover one side surface of the interlayer conductive layer 170 and one side surface of the positive electrode layer 110 or the negative electrode layer 120 sandwiching the interlayer conductive layer 170. In the illustrated example (FIG. 1), the solid-state electrolyte layer 130 may cover one side surface of each of the positive electrode active material layer 111 and the positive electrode current collector layer 112 sandwiching the interlayer conductive layer 170 and one side surface of the interlayer conductive layer 170. According to such a covering aspect, since one side surface of the positive electrode layer 110 or the negative electrode layer 120 is covered with the solid-state electrolyte layer, an unintended short circuit of the electrode layer can be prevented.

As a more preferred aspect of covering with the solid-state electrolyte layer 130, the solid-state electrolyte layer 130 may cover the one side surfaces so as to straddle the current collector layer and the active material layer sandwiching the interlayer conductive layer 170. In other words, the outer surface of the current collector layer and the outer surface of the active material layer excluding the side surface where the current collector layer is exposed from the solid-state battery element may be covered with the solid-state electrolyte layer 130. According to the covering aspect, an unintended short circuit of the electrode layer can be effectively prevented.

### 2. Interlayer Conductive Layer

The interlayer conductive layer 170 is located between the solid-state battery elements 141. More specifically, the interlayer conductive layer 170 is sandwiched between the positive electrode layer 110 or the negative electrode layer 120 of one solid-state battery element 141 and the positive electrode layer 110 or the negative electrode layer 120 of the other solid-state battery element 141.

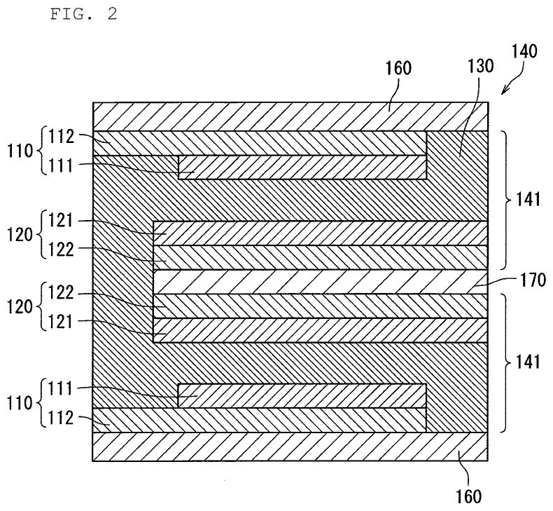

In FIG. 1 illustrating an example, the interlayer conductive layer 170 may be sandwiched between the positive electrode layers 110. Note that the present disclosure is not limited to this example, and the interlayer conductive layer 170 may be sandwiched between the negative electrode layers 120 (refer to FIG. 2). That is, the interlayer conductive layer 170 may be sandwiched between electrode layers having the same polarity. Accordingly, the electrode layers having the same polarity can be made conductive with each other.

The interlayer conductive layer 170 has conductivity. Therefore, the positive electrode layers 110 or the negative electrode layers 120 in contact with the interlayer conductive layer 170 on both sides in the stacking direction can be made conductive with each other.

The constituent material used for the interlayer conductive layer 170 may contain a conductive material and a solid-state electrolyte.

As the conductive material used for the interlayer conductive layer 170 that electrically connects the positive electrode current collector layers 112 to each other, for example, at least one selected from the group consisting of a carbon material, silver, palladium, gold, platinum, aluminum, copper, a nickel lithium transition metal composite oxide, and a lithium transition metal phosphate compound may be used.

As the conductive material used for the interlayer conductive layer 170 that electrically connects the negative electrode current collector layers 122 to each other, at least one selected from the group consisting of a carbon material, silver, palladium, gold, platinum, aluminum, copper, and nickel may be used.

As a specific material of the solid-state electrolyte, the materials described in detail in “1-2. Solid-state electrolyte layer” may be used. Further, the solid-state electrolyte ratio is 10 wt % to 35 wt % on the entire interlayer conductive layer 170. Note that, in the present disclosure, since the interlayer conductive layer is composed of a conductive material and a solid-state electrolyte, when the solid-state electrolyte ratio in the interlayer conductive layer is 10 wt % on the whole basis, the conductive material is 90 wt %, and when the solid-state electrolyte ratio in the interlayer conductive layer is 35 wt % on the whole basis, the conductive material is 65 wt %. Within this numerical range, the strength of the interlayer conductive layer 170 can be made lower than the strength of the positive electrode layer 110 or the negative electrode layer 120 sandwiching the interlayer conductive layer 170. Therefore, when a stress is accumulated inside the solid-state battery, the stress can be concentrated on the interlayer conductive layer 170 having a low strength, and as an example, the stress can be alleviated by generating cracks in the interlayer conductive layer 170. Note that, when the solid-state electrolyte of the interlayer conductive layer 170 is 10 wt % or less, it is difficult to maintain the shape as a sintered body. Thus, at least the interlayer conductive layer 170 contains the solid-state electrolyte in an amount of 10 wt % or more. Details of the numerical range of the solid-state electrolyte ratio will be described later in “Examples”.

Next, as an additional configuration of the solid-state battery of the present disclosure, a terminal electrode, an insulating outer layer, a covering insulating film, an inorganic film, and a support substrate will be described.

### 3. Terminal Electrode

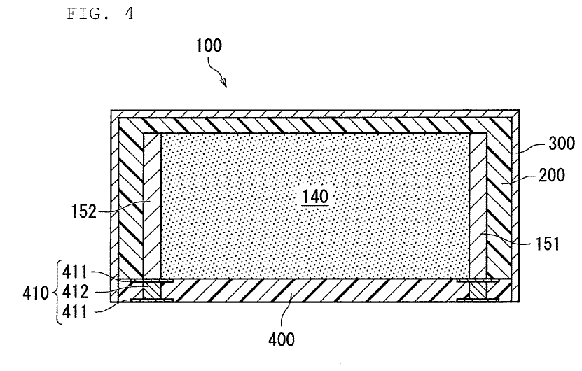

The terminal electrode is provided on an end surface of the laminate 140. As an example, in FIG. 4, the terminal electrodes 151, 152 may be provided on each side surface of the laminate 140 located in a direction intersecting the stacking direction of the laminate 140.

More specifically, the terminal electrode may be provided with a positive electrode-side terminal electrode 151 connected to the positive electrode layer 110 and a negative electrode-side terminal electrode 152 connected to the negative electrode layer 120 may be provided, and the positive electrode-side terminal electrode 151 may be formed on one side surface (the right side in FIG. 4), and the negative electrode-side terminal electrode 152 may be provided so as to face the positive electrode-side terminal electrode 151 (the left side in FIG. 4).

The terminal electrodes 151, 152 may contain a conductive material. The conductive material is a material having conductivity, and specific examples thereof include a carbon material and a metal material. The term “conductive” as used herein means that the volume resistivity is 107 Ω·cm or less.

The metal material is not particularly limited as long as it has conductivity, and examples thereof include at least one selected from the group consisting of silver, gold, platinum, aluminum, copper, palladium, zinc, tin, and nickel. In addition, a composite metal such as Ag-coated Cu and/or Ag-coated CuNi may be used. Incidentally, silver is exemplified as a preferable metal material because the conductivity is high and the change in conductivity is small as well under a high-temperature and high-humidity environment.

### 4. Insulating Outer Layer

As an additional configuration of the solid-state battery of the present disclosure, an insulating outer layer 160 may be provided. Specifically, an insulating outer layer 160 may be provided outside the laminate 140 (refer to FIGS. 1 to 3). The insulating outer layer 160 can be generally formed on the outermost side of the laminate 140, and used to electrically, physically, and/or chemically protect the laminate 140. Particularly, the insulating outer layer 160 includes an insulating outer layer 160 on the top surface side of the solid-state battery 100 and an insulating outer layer 160 on the bottom surface side of the solid-state battery 100. In addition, the insulating outer layer 160 may be provided on a side surface of the laminate 140 on which the terminal electrodes 151, 152 are not provided (a side surface of the solid-state battery element 141 in a direction perpendicular to the paper surface in FIG. 4). The material constituting the insulating outer layer is preferably excellent in insulation property, durability and/or moisture resistance and environmentally safe, and may contain, for example, a resin material, a glass material and/or a ceramic material. Further, the insulating outer layer may have a form of a fired body for production by integral firing. Note that the insulating outer layer 160 may not be provided, and the insulating outer layer may be included in other resins or ceramic packages.

### 5. Covering Insulating Film

As an additional configuration of the solid-state battery of the present disclosure, a covering insulating film 200 may be provided. The covering insulating film 200 may be provided so as to cover the terminal electrodes 151, 152 and the laminate 140 (refer to FIG. 4). The covering insulating film 200 preferably corresponds to a resin. That is, the covering insulating film 200 preferably contains a resin material. As can be seen from the aspect illustrated in FIG. 4, this means that the laminate 140 provided on a support substrate 400 is sealed with a resin material of the covering insulating film 200. The covering insulating film 200 formed of such a resin material suitably contributes to reduction of entry of moisture in combination with an inorganic film 300.

The material of the covering insulating film may be any type as long as it exhibits insulating properties. For example, when the covering insulating film contains a resin, the resin may be either a thermosetting resin or a thermoplastic resin. Although not particularly limited, specific examples of the resin material of the covering insulating film include an epoxy-based resin, a silicone-based resin, and/or a liquid crystal polymer. Although it is merely an example, the thickness of the covering insulating film may be 30 μm to 1000 μm, and is, for example, 50 μm to 300 μm.

In the solid-state battery, the covering insulating film is not essential, and a solid-state battery in which the covering insulating film is not provided is also conceivable.

### 6. Inorganic Film

As an additional configuration of the solid-state battery of the present disclosure, the inorganic film 300 covering the covering insulating film 200 may be provided. As illustrated in FIG. 4, since the inorganic film 300 is positioned on the covering insulating film 200, the inorganic film largely encloses the laminate 140 on the support substrate 400 as a whole together with the covering insulating film 200.

The inorganic film 300 preferably has a thin film form. A material of the inorganic film is not particularly limited as long as it contributes to the inorganic film having a thin film form, and may be metal, glass, oxide ceramics, a mixture thereof, or the like. In a preferred aspect, the inorganic film may contain a metal component. That is, the inorganic film may be preferably a metal thin film. Although it is merely an example, the thickness of such an inorganic film may be 0.1 μm to 100 μm, and is, for example, 1 μm to 50 μm.

In particular, depending on the production method, the inorganic film 300 may be a dry plating film. Such a dry plating film is a film obtained by a vapor phase method such as physical vapor deposition (PVD) or chemical vapor deposition (CVD), and has a very small thickness on the nano order or the micron order. Such a thin dry plating film contributes to more compact packaging.

The dry plating film may contain, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon (Si), SUS, and the like, an inorganic oxide, a glass component, and/or the like. Since the dry plating film including such a component is chemically and/or thermally stable, a solid-state battery having excellent chemical resistance, weather resistance, heat resistance, and/or the like and further improved long-term reliability can be provided.

In the solid-state battery, the inorganic film is not essential, and a solid-state battery in which the inorganic film is not provided is also conceivable.

### 7. Support Substrate

As an additional configuration of the solid-state battery of the present disclosure, the support substrate 400 may be provided. The support substrate 400 is a substrate disposed so as to support the laminate 140. The support substrate is positioned on one side that forms a main surface of the solid-state battery so as to serve as the “support”. The support substrate preferably has a thin plate-like form as a whole because of the “substrate”.

The support substrate 400 may be, for example, a resin substrate or a ceramic substrate, and is preferably a substrate having water resistance. In a preferred aspect, the support substrate 400 may be a ceramic substrate. That is, the support substrate 400 contains ceramic, and the ceramic may occupy a base material component of the substrate. The support substrate formed from ceramic contributes to prevention of water vapor transmission, and is thus a preferred substrate in terms of heat resistance and the like in substrate mounting. Such a ceramic substrate can be obtained through firing, and for example, can be obtained by firing a green sheet laminate. In this regard, the ceramic substrate may be, for example, a low temperature co-fired ceramics (LTCC) board or a high temperature co-fired ceramics (HTCC) board. Although it is merely an example, the thickness of the support substrate may be 20 μm to 1000 μm, and is, for example, 100 μm to 300 μm.

Further, the support substrate 400 may function as a terminal substrate of the laminate 140. That is, the solid-state battery packaged in a form in which the substrate is interposed can be mounted on another secondary substrate such as a printed wiring board. For example, the solid-state battery can be surface-mounted with a support substrate interposed between the battery and device through solder reflow and the like. From the above, the packaged solid-state battery may be an SMD type battery. In particular, when the terminal substrate includes a ceramic substrate, the solid-state battery can be an SMD type battery having high heat resistance and being solder-mountable.

Because of the terminal substrate, it is preferable to include wiring, and in particular, it is preferable to include wiring 410 (refer to FIG. 4) that electrically connects upper and lower surfaces or upper and lower surface layers. That is, a support substrate of a preferred aspect includes wiring that electrically wires upper and lower surfaces of the substrate, and may be a terminal substrate for an external terminal of a packaged solid-state battery.

The wiring 410 in the terminal substrate is not particularly limited, and may have any form as long as it contributes to electrical connection between the upper surface and the lower surface of the substrate. Since the form contributes to electrical connection, it can be said that the wiring 410 in the terminal substrate is a conductive portion of the substrate. Such a conductive portion of the substrate may have the form of a wiring layer, a via, a land, and/or the like. For example, in the aspect illustrated in FIG. 4, vias 412 and/or lands 411 are provided in the support substrate 400. The “via” referred to herein refers to a member for electrically connecting the vertical direction of the support substrate, that is, the substrate thickness direction, and for example, a filled via or the like is preferable, and may be in the form of an inner via or the like. The term “land” used in the present specification refers to a terminal portion/connection portion (preferably a terminal portion/connection portion connected to the via) for electrical connection provided on an upper main surface and/or a lower main surface of the support substrate, and may be, for example, a corner land or a round land.

### [Configuration of Electronic Device]

In the electronic device of the present disclosure, the above-described solid-state battery is surface-mounted. Specifically, the wiring of the support substrate 400 enables surface mounting of the solid-state battery. The term “surface mounting” as used herein intends a technique for directly fixing a solid-state battery to a pattern formed on a substrate. As an example, the solid-state battery 1 described above may be mounted on a printed circuit board or the like and packaged. Further, electronic components other than the solid-state battery may be mounted.

### [Method for Manufacturing Solid-State Battery]

The solid-state battery of the present disclosure is manufactured through a process including: (1) preparation of a laminate; (2) preparation of a terminal electrode material; (3) firing of the laminate; (4) application of the terminal electrode material; (5) curing of the terminal electrode material; (6) fixation to a support substrate; and (7) formation of a covering insulating film and an inorganic film. Hereinafter, description will be made in order.

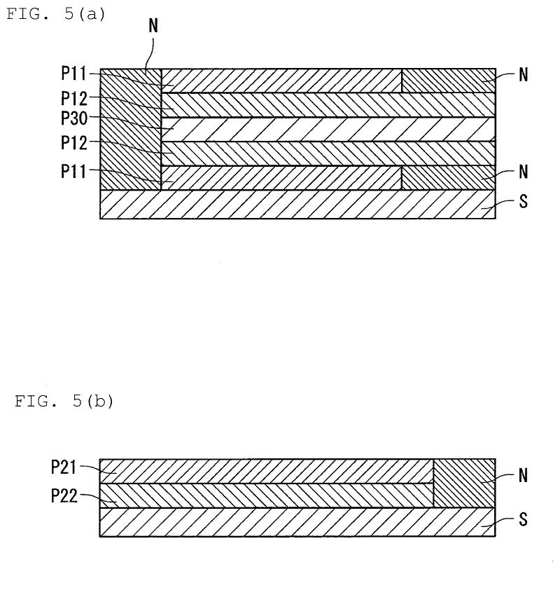

(1) Preparation of Laminate (Refer to FIGS. 5(a) and 5(b))

In the manufacturing of the laminate, a sheet containing a solid-state electrolyte, a positive electrode active material layer paste, a positive electrode current collector layer paste, a negative electrode active material layer paste, a negative electrode current collector layer paste, and an interlayer conductive layer paste are produced.

As for the sheet containing a solid-state electrolyte, a slurry is prepared by mixing a solid-state electrolyte, an organic binder, a solvent, and an optional additive, and a sheet is formed from the prepared slurry by firing.

The positive electrode active material, the solid-state electrolyte, the conductive material, the organic binder, the solvent, and optional additives are mixed to prepare a positive electrode active material paste. The solid-state electrolyte, the conductive material, the organic binder, the solvent, and optional additives are mixed to prepare a positive electrode current collector layer paste. The solid-state electrolyte ratio in the positive electrode current collector layer paste is 40 wt % to 60 wt % on the whole basis.

The negative electrode active material, the solid-state electrolyte, the conductive material, the organic binder, the solvent, and optional additives are mixed to prepare a negative electrode active material paste. The solid-state electrolyte, the conductive material, the organic binder, the solvent, and optional additives are mixed to prepare a negative electrode current collector layer paste. The solid-state electrolyte ratio in the negative electrode current collector layer paste is 40 wt % to 60 wt % on the whole basis.

The solid-state electrolyte, the conductive material, the organic binder, the solvent, and optional additives are mixed to prepare an interlayer conductive layer paste. The solid-state electrolyte ratio in the interlayer conductive layer paste is 10 wt % to 35 wt % on the whole basis.

After the above-described pastes are prepared, the procedure proceeds to preparation of a laminate. A negative electrode current collector layer paste P22 is printed on a sheet S containing a solid-state electrolyte, and a negative electrode active material paste P21 is printed on the negative electrode current collector layer paste P22. Further, as necessary, a solid electrolyte part N acting as a solid-state electrolyte may be printed (refer to FIG. 5(b)). The solid electrolyte part N is intended as a slurry prepared by mixing a solid-state electrolyte, an organic binder, a solvent, and arbitrary additives together.

Further, a positive electrode active material paste P11 is printed on another sheet S containing a solid-state electrolyte, and a positive electrode current collector layer paste P12 is printed on the positive electrode active material paste P11. As necessary, the solid electrolyte part N acting as a solid-state electrolyte may be printed (refer to FIG. 5(a)). An interlayer conductive layer paste P30 is printed on the positive electrode current collector layer paste. The positive electrode current collector layer paste P12 and the positive electrode active material paste P11 are sequentially printed on the interlayer conductive layer paste P30. As necessary, the solid electrolyte part N acting as a solid-state electrolyte may be printed. The sheet with the negative electrode paste applied by printing and the sheet with the positive electrode paste applied by printing are alternately stacked to obtain a laminate. Further, the outermost layer (the uppermost layer and/or the lowermost layer) of the laminate may be an electrolyte layer, an insulating layer, or an electrode layer.

### (2) Preparation of Terminal Electrode Material

First, a terminal electrode material (as an example, a conductive paste) to be a material of the terminal electrodes 151, 152 is prepared. As the conductive material, Ag is prepared. Here, as an additional element, a resin and a solvent may be further contained to form a terminal electrode material. The term “terminal electrode material” as used herein refers to a material capable of forming a flow in a hydrodynamic sense or a material capable of maintaining such a flow. Examples of such materials include liquids such as pastes, solutions or suspensions.

The solvent dissolves the above-mentioned resin binder, and for example, an organic solvent may be used. The organic solvent is not particularly limited, and alcohols including methanol, ethanol, 1-propanol, 2-propanol, hexanol, and cyclohexanol, glycols including ethylene glycol and propylene glycol, ketones including methyl ethyl ketone, diethyl ketone, and methyl isobutyl ketone, terpenes including α-terpineol, β-terpineol, and γ-terpineol, ethylene glycol monoalkyl ethers, ethylene glycol dialkyl ethers, diethylene glycol monoalkyl ethers, diethylene glycol dialkyl ethers, ethylene glycol monoalkyl ether acetates, ethylene glycol dialkyl ether acetates, diethylene glycol monoalkyl ether acetates, diethylene glycol dialkyl ether acetates, propylene glycol monoalkyl ethers, propylene glycol dialkyl ethers, propylene glycol monoalkyl ether acetates, propylene glycol dialkyl ether acetates, and/or monoalkyl cellosolves can be used alone, a mixture including at least one solvent or two or more solvents selected from these solvents can also be used. As an example of the organic solvent, an alcohol-based solvent such as terpineol is preferably used. A dispersant may be added to the solvent.

After preparing the terminal electrode material, the terminal electrode material is applied to the positive electrode exposed side surface and the negative electrode exposed side surface of the battery element body.

### (3) (Firing of Laminate)

Although the firing of the laminate is merely an example, the firing is performed by heating the battery element body in a nitrogen gas atmosphere containing oxygen gas or in the atmosphere at a desired firing temperature (for example, the firing peak temperature is in the range of 300° C. to 600° C.). Firing may be performed while pressurizing the laminate precursor in the stacking direction (in some cases, stacking direction and direction perpendicular to the stacking direction).

### (4) Application of Terminal Electrode Material

After preparing the terminal electrode material, the terminal electrode material is applied to the positive electrode exposed side surface and the negative electrode exposed side surface of the laminate.

### (5) Curing of Terminal Electrode Material

The laminate applied to the positive electrode exposed side surface and the negative electrode exposed side surface is cured at a desired curing temperature (for example, in the range of 100° C. to 300° C.).

### (6) Fixation to Support Substrate

The support substrate is provided with vias and/or lands to enable surface mounting on the secondary board. For example, the support substrate can be obtained by stacking and firing a plurality of green sheets. This is particularly true when the support substrate is a ceramic substrate. The preparation of the support substrate can be performed, for example, in accordance with the preparation of the LTCC substrate.

The via and/or the land in the support substrate is manufactured by, for example, a method of forming a hole (diameter size: about 50 μm to 200 μm) by a punch press, a carbon dioxide laser, or the like and filling the hole with a conductive paste material, or a method using a printing method.

After the support substrate is produced, the conductive portion of the support substrate and the terminal electrode of the laminate are disposed so as to be electrically connected to each other. In addition, a conductive paste may be provided on the support substrate to thereby electrically connect the conductive portions of the support substrate and the terminal electrodes to each other. As the conductive paste, in addition to an Ag conductive paste, a conductive paste that does not require washing, such as a flux, after formation, such as a nano paste, an alloy-based paste, or a brazing material, can be used.

### (7) Formation of Covering Insulating Film and Inorganic Film

Subsequently, the covering insulating film is formed so as to cover the laminate on the support substrate. Thus, a raw material of the covering insulating film is provided so that the battery element body on the support substrate is covered as a whole. When the covering insulating film is formed from a resin material, a resin precursor is provided on the support substrate and, for example, cured to mold the covering insulating film.

In a preferred aspect, the covering insulating film may be molded by pressurization with a mold. Although it is merely an example, the covering insulating film that seals the battery element body on the support substrate may be molded through compression molding. In the case of a resin material generally used in a mold, the form of the raw material of the covering insulating film may be granular, and the type thereof may be thermoplastic. Such molding is not limited to die molding, and may be performed through polishing processing, laser processing, and/or chemical treatment.

Next, the inorganic film is formed. For the inorganic film, for example, dry plating may be performed, and a dry plating film may be used as the inorganic film. More specifically, dry plating is performed to form the inorganic film on an exposed surface other than a bottom surface of a covering precursor (that is, other than the bottom surface of the support substrate). In a preferred aspect, sputtering is performed to form a sputtered film on the exposed outer surface other than the bottom surface of the covering precursor.

Through the above steps, a solid-state battery of the present disclosure can be finally obtained.

### Examples

Demonstration tests were conducted on the solid-state battery of the present disclosure. Specifically, solid-state batteries of Examples 1 to 5, and Comparative Examples 1 to 5 shown below were manufactured.

### <Common Configuration in Examples>

As illustrated in FIG. 1, solid-state batteries of Examples 1 to 5 each adopted a structure in which two solid-state battery elements 141 are stacked with the interlayer conductive layer 170 interposed therebetween and the interlayer conductive layer 170 is sandwiched between the positive electrode layers 110. As a material of each layer, as an example, the positive electrode active material layer 111 was LiCoO₂, and the positive electrode current collector layer 112, the negative electrode active material layer 121, the negative electrode current collector layer 122, and the interlayer conductive layer 170 were carbon materials. Note that the material, the number of stacked layers, and the like of each layer are not limited to this example.

### <Configuration Unique to Example 1>

As the solid-state battery of Example 1, the solid-state electrolyte ratios of the positive electrode current collector layer and the interlayer conductive layer were set as follows.

Positive electrode current collector layer: conductive material (50 wt %), solid-state electrolyte (50 wt %)

Interlayer conductive layer: conductive material (80 wt %), solid-state electrolyte (20 wt %)

### <Configuration Unique to Example 2>

As the solid-state battery of Example 2, the solid-state electrolyte ratios of the positive electrode current collector layer and the interlayer conductive layer were set as follows.

Positive electrode current collector layer: conductive material (50 wt %), solid-state electrolyte (50 wt %)

Interlayer conductive layer: conductive material (90 wt %), solid-state electrolyte (10 wt %)

### <Configuration Unique to Example 3>

As the solid-state battery of Example 3, the solid-state electrolyte ratios of the positive electrode current collector layer and the interlayer conductive layer were set as follows.

Positive electrode current collector layer: conductive material (50 wt %), solid-state electrolyte (50 wt %)

Interlayer conductive layer: conductive material (65 wt %), solid-state electrolyte (35 wt %)

### <Configuration Unique to Example 4>

As the solid-state battery of Example 4, the solid-state electrolyte ratios of the positive electrode current collector layer and the interlayer conductive layer were set as follows.

Positive electrode current collector layer: conductive material (60 wt %), solid-state electrolyte (40 wt %)

Interlayer conductive layer: conductive material (80 wt %), solid-state electrolyte (20 wt %)

### <Configuration Unique to Example 5>

As the solid-state battery of Example 5, the solid-state electrolyte ratios of the positive electrode current collector layer and the interlayer conductive layer were set as follows.

Positive electrode current collector layer: conductive material (40 wt %), solid-state electrolyte (60 wt %)

Interlayer conductive layer: conductive material (80 wt %), solid-state electrolyte (20 wt %)

### <Configuration of Comparative Example 1>

As the solid-state battery of Comparative Example 1, a solid-state battery not provided with an interlayer conductive layer was manufactured. Further, the positive electrode current collector layer was set as follows.

Positive electrode current collector layer: conductive material (80 wt %), solid-state electrolyte (20 wt %)

### <Configuration of Comparative Example 2>

As the solid-state battery of Comparative Example 2, instead of the solid-state electrolyte ratios of the solid-state battery of Example 1, the solid-state electrolyte ratios were set as follows.

Positive electrode current collector layer: conductive material (50 wt %), solid-state electrolyte (50 wt %)

Interlayer conductive layer: conductive material (95 wt %), solid-state electrolyte (5 wt %)

### <Configuration of Comparative Example 3>

As the solid-state battery of Comparative Example 3, instead of the solid-state electrolyte ratios of the solid-state battery of Example 1, the solid-state electrolyte ratios were set as follows.

Positive electrode current collector layer: conductive material (50 wt %), solid-state electrolyte (50 wt %)

Interlayer conductive layer: conductive material (60 wt %), solid-state electrolyte (40 wt %)

### <Configuration of Comparative Example 4>

As the solid-state battery of Comparative Example 4, instead of the solid-state electrolyte ratios of the solid-state battery of Example 1, the solid-state electrolyte ratios were set as follows.

Positive electrode current collector layer: conductive material (30 wt %), solid-state electrolyte (70 wt %)

Interlayer conductive layer: conductive material (80 wt %), solid-state electrolyte (20 wt %)

### <Configuration of Comparative Example 5>

As the solid-state battery of Comparative Example 5, instead of the solid-state electrolyte ratios of the solid-state battery of Example 1, the solid-state electrolyte ratios were set as follows.

Positive electrode current collector layer: conductive material (70 wt %), solid-state electrolyte (30 wt %)

Interlayer conductive layer: conductive material (80 wt %), solid-state electrolyte (20 wt %)

The solid-state batteries of Examples 1 to 5 and Comparative Examples 1 to 5 were subjected to a high-temperature charge-discharge cycle short-circuit test and a production aptitude test. The contents of each test are shown below.

### —High-Temperature Charge-Discharge Cycle Short-Circuit Test—

A charge-discharge cycle test was performed at a design voltage and a design current using a charge-discharge test apparatus (TOSCAT-3100) manufactured by Toyo System Corporation, and a short-circuit occurrence rate of the solid-state battery was confirmed. Note that, in this test, the index of the short-circuit occurrence rate is as follows.
⊙: Short-circuit occurrence rate of 20% or less
◯: Short-circuit occurrence rate of more than 20% and 60% or less
x: Short-circuit occurrence rate of more than 60%

### —Production Aptitude Test—

In the production aptitude test, the presence or absence of shape abnormality was visually inspected when the solid-state battery was produced. The index of the occurrence rate of shape abnormality is as follows.
⊙: Shape abnormality rate of 10% or less
◯: Shape abnormality rate of more than 10% and 30% or less
x: Shape abnormality rate of more than 30%

The above test results are shown in the following table.

TABLE 1

| | Exam- | Exam- | Exam- | Exam- | Exam- |
|---|---|---|---|---|---|
| | ple 1 | ple 2 | ple 3 | ple 4 | ple 5 |
| Solid-state | 50 wt % | 50 wt % | 50 wt % | 40 wt % | 60 wt % |
| electrolyte ratio of | | | | | |
| positive electrode | | | | | |
| current collector | | | | | |
| layer | | | | | |
| Solid-state | 20 wt % | 10 wt % | 35 wt % | 20 wt % | 20 wt % |
| electrolyte ratio of | | | | | |
| interlayer | | | | | |
| conductive layer | | | | | |
| High-temperature | ⊙ | ◯ | ◯ | ◯ | ◯ |
| charge-discharge | | | | | |
| test | | | | | |
| Production aptitude | ⊙ | ◯ | ⊙ | ⊙ | ⊙ |
| test | | | | | |
| | Comparative | Comparative | Comparative | Comparative | Comparative |
| | Example 1 | Example 2 | Example 3 | Example 4 | Example 5 |
| Solid-state | 20 wt % | 50 wt % | 50 wt % | 70 wt % | 30 wt % |
| electrolyte ratio | | | | | |
| of positive | | | | | |
| electrode current | | | | | |
| collector layer | | | | | |
| Solid-state | None | 5 wt % | 40 wt % | 20 wt % | 20 wt % |
| electrolyte | | | | | |
| ratio of | | | | | |
| interlayer | | | | | |
| conductive layer | | | | | |
| High-temperature | X | — | X | — | X |
| charge-discharge | | | | | |
| test | | | | | |
| Production | ◯ | X | ◯ | ◯ | ◯ |
| aptitude test | | | | | |

According to the above test results, in the solid-state batteries of Examples 1 to 5, since the solid-state electrolyte ratio of the positive electrode layer sandwiching the interlayer conductive layer is in a range of 40 wt % to 60 wt %, and the solid-state electrolyte ratio of the interlayer conductive layer is 10 wt % to 35 wt % based on the layer containing a solid-state electrolyte, the high-temperature charge-discharge test and the production aptitude test showed favorable results. In particular, the solid-state battery of Example 1 showed more favorable results than the demonstration tests of the solid-state batteries of Examples 2 to 5.

On the other hand, since the solid-state battery of Comparative Example 1 did not include an interlayer conductive layer, a short circuit occurred due to the stress of the solid-state battery. In the solid-state battery of Comparative Example 2, since the solid-state electrolyte ratio of the interlayer conductive layer was low, the shape of the sintered body could not be maintained, and the solid-state battery could not be manufactured in the first place. In the solid-state batteries of Comparative Example 3 and Comparative Example 5, since a difference between the solid-state electrolyte ratio of the interlayer conductive layer and the solid-state electrolyte ratio of the positive electrode current collector layer was small, the effect of alleviating a stress due to a difference in strength could not be obtained. Since the solid-state electrolyte ratio of the positive electrode current collector layer was relatively high and high resistance was achieved, the solid-state battery of Comparative Example 4 did not act as a solid-state battery, and the high-temperature charge-discharge test could not be performed.

According to the demonstration tests (the high-temperature charge-discharge test and the production aptitude test), when the solid-state electrolyte ratio of the positive electrode layer or the negative electrode layer sandwiching the interlayer conductive layer is in a range of 40 wt % to 60 wt %, and the solid-state electrolyte ratio of the interlayer conductive layer is 10 wt % to 35 wt % based on the layer containing a solid-state electrolyte, a result was obtained that the stress based on the volume change could be alleviated.

Aspects of the solid-state battery and the electronic device of the present disclosure are as follows.
<1> A solid-state battery including: a plurality of solid-state battery elements in which a positive electrode layer, a negative electrode layer, and a solid-state electrolyte layer interposed between the positive electrode layer and the negative electrode layer are stacked; and an interlayer conductive layer sandwiched between the positive electrode layer or the negative electrode layer of a first solid-state battery element and the positive electrode layer or the negative electrode layer of a second solid-state battery element of the plurality of solid-state battery elements, in which the positive electrode layer or the negative electrode layer sandwiching the interlayer conductive layer contains a solid-state electrolyte, a solid-state electrolyte ratio of the positive electrode layer or the negative electrode layer sandwiching the interlayer conductive layer is 40 wt % to 60 wt % based on an entirety of the positive electrode layer or the negative electrode layer, and a solid-state electrolyte ratio of the interlayer conductive layer is 10 wt % to 35 wt % based on an entirety of the interlayer conductive layer.
<2> The solid-state battery according to <1>, in which the positive electrode layer or the negative electrode layer includes an active material layer containing an electrode active material and a current collector layer in contact with the interlayer conductive layer, and the solid-state electrolyte is contained in the current collector layer.
<3> The solid-state battery according to <2>, in which, in a sectional view of the solid-state battery, the current collector layer extends to an end portion of the solid-state battery element, and the active material layer is located inside the end portion.
<4> The solid-state battery according to <2> or <3>, in which the active material layer of each of the positive electrode layer or the negative electrode layer located on opposite sides of the interlayer conductive layer is inside a facing counter electrode.
<5> The solid-state battery according to <4>, in which the facing counter electrode includes an active material layer containing an electrode active material and a current collector layer in contact with the interlayer conductive layer, and the active material layer of the each of the positive electrode layer or the negative electrode layer on the opposite sides of the interlayer conductive layer are inside the active material layer of the facing counter electrode.
<6> The solid-state battery according to any one of <1> to <5>, in which the interlayer conductive layer is sandwiched between electrode layers having the same polarity.
<7> The solid-state battery according to any one of <1> to <6>, in which the plurality of the solid-state battery elements are electrically connected in parallel to each other.
<8> The solid-state battery according to any one of <1> to <7>, in which a first side surface of the interlayer conductive layer and a second side surface of the positive electrode layer or the negative electrode layer sandwiching the interlayer conductive layer are covered with the solid-state electrolyte layer.
<9> The solid-state battery according to any one of <1> to <8>, in which the solid-state electrolyte layer covers the first and second side surfaces so as to straddle the current collector layer and the active material layer sandwiching the interlayer conductive layer.
<10> The solid-state battery according to any one of <1> to <9>, in which the solid-state battery element is a sintered body.
<11> The solid-state battery according to any one of <1> to <10>, in which the solid-state battery is packaged to be surface-mounted.
<12> The solid-state battery according to any one of <1> to <11>, in which the positive electrode layer and the negative electrode layer are layers capable of occluding and releasing lithium ions.
<13> An electronic device that includes the solid-state battery according to any one of <1> to <12> surface-mounted therein.

Note that the embodiments disclosed herein are considered by way of illustration in all respects, and not considered as a basis for restrictive interpretations. Therefore, the technical scope of the present disclosure is not to be construed only by the above-described embodiments, but is defined based on the description of the claims. Further, the technical scope of the present disclosure includes meanings equivalent to the claims and all modifications within the scope. For example, the solid-state battery is not limited to a substantially hexahedral shape, and may have a polyhedral shape, a cylindrical shape, or a spherical shape.

The packaged solid-state battery of the present disclosure can be used in various fields in which battery use or electricity storage is assumed. Although it is merely an example, the packaged solid-state battery of the present disclosure can be used in the electronics packaging field. The present disclosure can be used in electricity, information and communication fields where mobile equipment and the like are used (for example, electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (for example, the fields such as spacecraft and research submarines).

### DESCRIPTION OF REFERENCE SYMBOLS

100: Solid-state battery
110: Positive electrode layer
111: Positive electrode active material layer
112: Positive electrode current collector layer
120: Negative electrode layer
121: Negative electrode active material layer
122: Negative electrode current collector layer
130: Solid-state electrolyte layer
140: Laminate
141: Solid-state battery element
151: Positive electrode layer-side terminal electrode
152: Negative electrode layer-side terminal electrode
160: Insulating outer layer
170: Interlayer conductive layer
200: Covering insulating film
300: Inorganic film
400: Support substrate
410: Wiring
411: Land
412: Via
S: Sheet
P11: Positive electrode active material paste
P12: Positive electrode current collector layer paste
P21: Negative electrode active material paste
P22: Negative electrode current collector layer paste
P30: Interlayer conductive layer paste
N: Solid electrolyte part

1. A solid-state battery comprising:
a plurality of solid-state battery elements in which a positive electrode layer, a negative electrode layer, and a solid-state electrolyte layer interposed between the positive electrode layer and the negative electrode layer are stacked; and
an interlayer conductive layer sandwiched between the positive electrode layer or the negative electrode layer of a first solid-state battery element and the positive electrode layer or the negative electrode layer of a second solid-state battery element of the plurality of solid-state battery elements, wherein
the positive electrode layer or the negative electrode layer sandwiching the interlayer conductive layer contains a solid-state electrolyte,
a solid-state electrolyte ratio of the positive electrode layer or the negative electrode layer sandwiching the interlayer conductive layer is 40 wt % to 60 wt % based on an entirety of the positive electrode layer or the negative electrode layer, and
a solid-state electrolyte ratio of the interlayer conductive layer is 10 wt % to 35 wt % based on an entirety of the interlayer conductive layer.

2. The solid-state battery according to claim 1, wherein
the positive electrode layer or the negative electrode layer includes an active material layer containing an electrode active material and a current collector layer in contact with the interlayer conductive layer, and
the solid-state electrolyte is contained in the current collector layer.

3. The solid-state battery according to claim 2, wherein, in a sectional view of the solid-state battery, the current collector layer extends to an end portion of the solid-state battery element, and the active material layer is located inside the end portion.

4. The solid-state battery according to claim 2, wherein the active material layer of each of the positive electrode layer or the negative electrode layer located on opposite sides of the interlayer conductive layer is inside a facing counter electrode.

5. The solid-state battery according to claim 4, wherein
the facing counter electrode includes an active material layer containing an electrode active material and a current collector layer in contact with the interlayer conductive layer, and
the active material layer of the each of the positive electrode layer or the negative electrode layer on the opposite sides of the interlayer conductive layer are inside the active material layer of the facing counter electrode.

6. The solid-state battery according to claim 1, wherein the interlayer conductive layer is sandwiched between electrode layers having a same polarity.

7. The solid-state battery according to claim 1, wherein the plurality of the solid-state battery elements are electrically connected in parallel to each other.

8. The solid-state battery according to claim 1, wherein a first side surface of the interlayer conductive layer and a second side surface of the positive electrode layer or the negative electrode layer sandwiching the interlayer conductive layer are covered with the solid-state electrolyte layer.

9. The solid-state battery according to claim 1, wherein
the positive electrode layer or the negative electrode layer includes an active material layer containing an electrode active material and a current collector layer in contact with the interlayer conductive layer,
a first side surface of the interlayer conductive layer and a second side surface of the positive electrode layer or the negative electrode layer sandwiching the interlayer conductive layer are covered with the solid-state electrolyte layer so as to straddle the current collector layer and the active material layer sandwiching the interlayer conductive layer.

10. The solid-state battery according to claim 1, wherein the solid-state battery element is a sintered body.

11. The solid-state battery according to claim 1, wherein the solid-state battery is packaged to be surface-mounted.

12. The solid-state battery according to claim 1, wherein the positive electrode layer and the negative electrode layer are layers capable of storing and releasing lithium ions.

13. The solid-state battery according to claim 1, wherein the interlayer conductive layer contains a conductive material and the solid-state electrolyte.

14. The solid-state battery according to claim 1, wherein the interlayer conductive layer is sandwiched between the positive electrode layer of the first solid-state battery element and the positive electrode layer of the second solid-state battery element of the plurality of solid-state battery elements.

15. The solid-state battery according to claim 1, wherein the interlayer conductive layer is sandwiched between the negative electrode layer of the first solid-state battery element and the negative electrode layer of the second solid-state battery element of the plurality of solid-state battery elements.

16. An electronic device comprising the solid-state battery according to claim 1 surface-mounted therein.
